(19) United States
(12) Patent Application Publication
(10) Pub. No.: US 2012/0151736 A1
(43) Pub. Date: Jun. 21, 2012

(54) IMPLANT INSERTION DEVICE LOADING STATION

(75) Inventors: CYRIL BAUDOUIN, Oberdorf (CH); MICHAEL WHITE, Oberdorf (CH)

(73) Assignee: SYNTHES USA, LLC, West Chester, PA (US)

(21) Appl. No.: 12/969,548

(22) Filed: Dec. 15, 2010

(51) Int. Cl. B23P 11/00; B23P 19/00

(52) U.S. Cl. 29/428; 29/700

(57) ABSTRACT

A loading station for loading an implant into an insertion device comprises two holders. Each holder is adapted to receive an endplate of the implant, e.g., in a slot of the holder. The loading station may include a distraction block that is disposed on or integrated within one of the holders. The distraction block is adapted to receive the distal ends of the blades of the insertion device, and maintain the insertion device in a particular position. The distraction block is configured to distract the blades from each other, so that the user may insert the implant into the insertion device. Alternatively, each holder of the loading station may have recess guides to receive the blades of the insertion device, and separate the blades from each other as the insertion device is pushed towards the loading station.

### BACKGROUND

A spinal implant insertion device is a device that installs a spinal implant (e.g., a prosthesis or spacer (cage)) between two (e.g., a pair of adjacent) vertebrae, or wholly or partially within a vertebra, in the human spine. Such a device is typically operated manually, and may include a rod that the operator uses to push the implant into the intravertebral space. The insertion device may be used, for example, for an anterior approach, a posterior approach, a lateral approach, or any variation in between.

A perspective view of an example implant 100 is shown in FIG. 1 and a perspective view of an example insertion device 200 is shown in FIG. 2. The parts of the implant 100 that are shown in FIG. 1 include two endplates 110, 120 of the implant 100 and a clamp 130. The two endplates 110, 120 are coupled by the clamp 130, and are separated by a height. A shaft 114 of the clamp is also shown.

The parts of the insertion device 200 that are shown in FIG. 2 include a grip handle 212, a shaft 214, and a T-handle 216 on the end of the shaft 214. A pair of distracter springs 218, 219, which may be referred to as blades or paddles, may project forward from the grip handle 212. The shaft 214 may extend through the grip handle 212, and may project forward from the grip handle 212 between the blades 218, 219. A pusher block 220 may be received between the blades 218, 219. The pusher block 220 may be linked to or associated with the shaft 214 to be driven forward as the operator moves the T-handle 216 forward toward the grip handle 212. The pusher block 220 may then push the implant 100 forward between the distal ends 224, 225 of the blades 218, 219, respectively, which forces the blades 218, 219 apart from each other to simultaneously distract a pair of vertebrae and advance the implant 100 into the intravertebral space.

Currently, insertion devices are used in total disc replacement (TDR) or fusion surgeries to insert an implant with a simultaneous distraction of the space during insertion. However, it is difficult to safely mount the implant into the insertion device.

### SUMMARY

Described herein is a tool that enables an implant to be safely and efficiently placed into an insertion device.

In an implementation, a loading station for loading an implant into an insertion device comprises two holders. Each holder is adapted to receive a respective endplate of the implant, e.g., in a slot of the holder. The loading station may include a distraction block that is disposed on or integrated within one of the holders. The distraction block is adapted to receive the distal ends of the blades of the insertion device, and maintain the insertion device in a particular position. The distraction block is configured to distract the blades from each other, so that the user may insert the implant into the insertion device.

In accordance with further implementations there is provided a method for loading an implant into an insertion device using a loading station. The method may include loading one endplate of an implant into the loading station, loading the other endplate of the implant into the loading station, setting an optional adjustment mechanism corresponding to the implant height, and joining the two endplates of the implant together with a clamp. The insertion device is loaded onto the distraction block of the loading station, thereby separating the blades of the insertion device. The implant is removed from the loading station and mounted between the separated blades onto a pusher of the insertion device. The insertion device with the mounted implant may then be removed from the loading station.

In an implementation, the loading station comprises an adjustment mechanism, such as a height dial, disposed on one of the holders. The adjustment mechanism allows for controlled variation of the distance between the holders. This distance corresponds to the different implant heights of the implant. The adjustment mechanism may be turned or otherwise set to the distance corresponding to the height of the implant that is being inserted into the loading station for mounting within the insertion device.

In another implementation, instead of a holder having a distraction block, each holder of the loading station may have recess guides to receive the blades of the insertion device, and to separate the blades from each other as the insertion device is pushed towards the loading station.

In accordance with further implementations there is provided another method for loading an implant into an insertion device using a loading station. The method may include loading one endplate of an implant into the loading station, loading the other endplate of the implant into the loading station, setting an optional adjustment mechanism corresponding to the implant height, and joining the two endplates of the implant together with a clamp. The blades of the insertion device are separated or distracted against the edges of the holders of the loading station until teeth on the inside of the blades of the insertion device engage in recess guides of the loading station. The user may slide the loading station between the blades until the clamp shaft of the implant mates with the pusher of the insertion device, thereby locking the implant into the pusher. Then the user may remove the loading station, leaving the implant mounted in the insertion device. The blades of the insertion device retract automatically and the insertion device is ready for subsequent use.

This summary is provided to introduce a selection of concepts in a simplified form that are further described below in the detailed description. This summary is not intended to identify key features or essential features of the claimed subject matter, nor is it intended that this summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

To facilitate an understanding of and for the purpose of illustrating the present disclosure, exemplary features and implementations are disclosed in the accompanying drawings, it being understood, however, that the present disclosure is not limited to the precise arrangements and instrumentalities shown, and wherein similar reference characters denote similar elements throughout the several views, and wherein:

FIG. 1 is a perspective view of an example implant;

FIG. 2 is a perspective view of an example insertion device;

FIG. 3 is a perspective view of an implementation of an example loading station that may be used to load an implant into an insertion device;

FIGS. 4 and 5 are additional perspective views of the example loading station of FIG. 3;

FIG. 6 is a cross-sectional perspective view of the example loading station;

FIG. 7 is another cross-sectional perspective view of the example loading station;

FIG. 8 is a perspective view of the example loading station receiving an implant;

FIGS. 9 and 10 are additional perspective views of the example loading station receiving an implant;

FIG. 11 is a perspective view of the example loading station with a height dial;

FIG. 12 is a perspective view of two endplates of an implant mounted on an example loading station;

FIG. 13 is a perspective view of two endplates of an implant coupled by a clamp and mounted on the example loading station;

FIG. 14 is a perspective view of the example loading station with a distraction block in cross-section;

FIG. 15 is a perspective view of the example loading station with a mounted implant and receiving an insertion device in the distraction block;

FIG. 16 is a perspective view of the example loading station with a mounted implant and an insertion device mounted in the distraction block to receive the implant;

FIG. 17 is an operational flow diagram of exemplary processes that may be performed as part of a procedure using an implementation of an example loading station;

FIG. 18 is a perspective view of another implementation of an example loading station that may be used to load an implant into an insertion device;

FIG. 19 is an expanded perspective view of the example loading station of FIG. 18;

FIG. 20 is a cross-sectional perspective view of the example loading station of FIG. 18;

FIG. 21 is a perspective view of two endplates of an implant coupled by a clamp and mounted on the example loading station of FIG. 18;

FIGS. 22-25 are perspective views of a loading station, an implant, and an insertion device at various stages of mounting the implant onto the insertion device using the loading station;

FIG. 26 is a perspective view of an insertion device with a mounted implant; and

FIG. 27 is an operational flow diagram of exemplary processes that may be performed as part of a procedure using another implementation of an example loading station.

### DETAILED DESCRIPTION

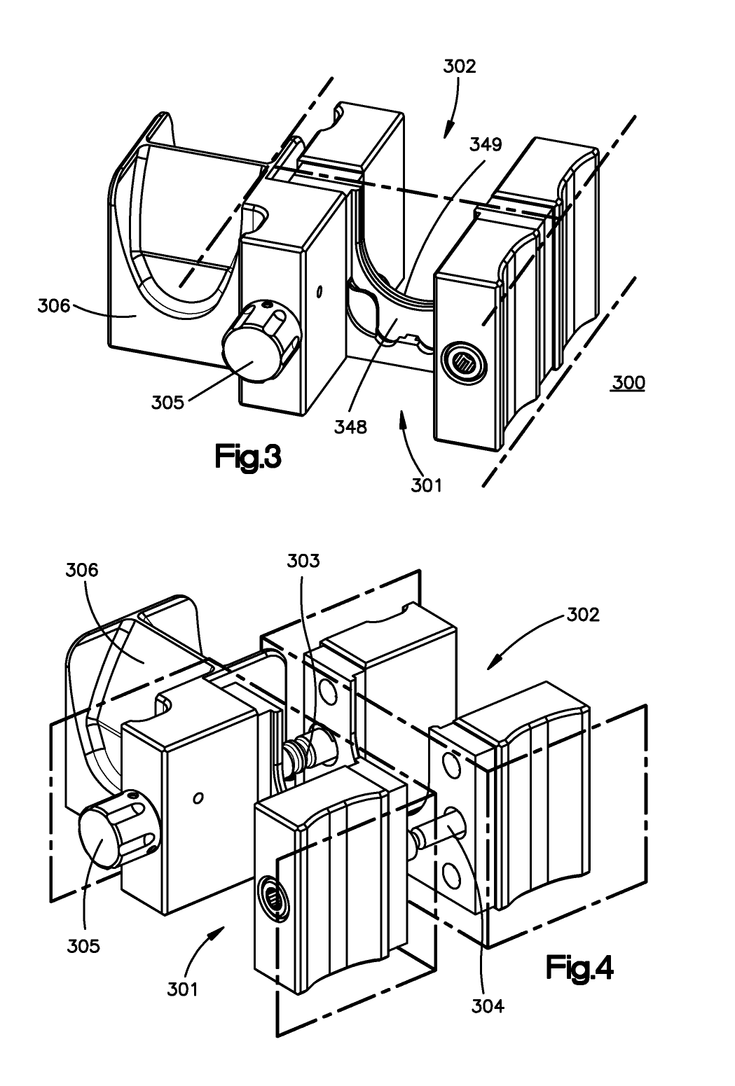

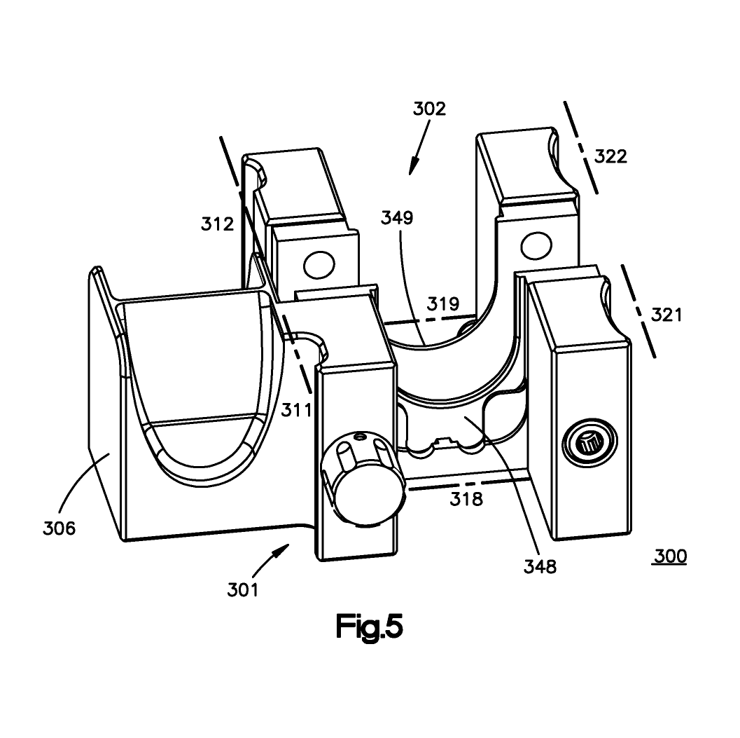

FIG. 3 is a perspective view of an implementation of an example loading station 300 that may be used to load an implant, such as the implant 100, into an insertion device, such as the insertion device 200. FIGS. 4 and 5 are additional perspective views of the example loading station 300. The loading station 300 comprises two holders 301, 302 that are coupled by two connection members 303, 304. In an implementation, each connection member may comprise one or more rods. Each holder is adapted to receive an endplate of the implant, e.g., in a slot of the holder. More particularly, each holder has a receiving portion, such as a slot or groove, which is sized and configured to receive a portion of the implant, such as an endplate of the implant. For example, as described further herein, the holder 301 is adapted to receive the endplate 120 of the implant 100 in a slot 348 or a groove, and the holder 302 is adapted to receive the endplate 110 in a slot 349 or a groove. The slots 348, 349 may be any shape to receive and maintain the endplates 110, 120 in a particular position (e.g., upright or vertical, etc.) depending on the implementation.

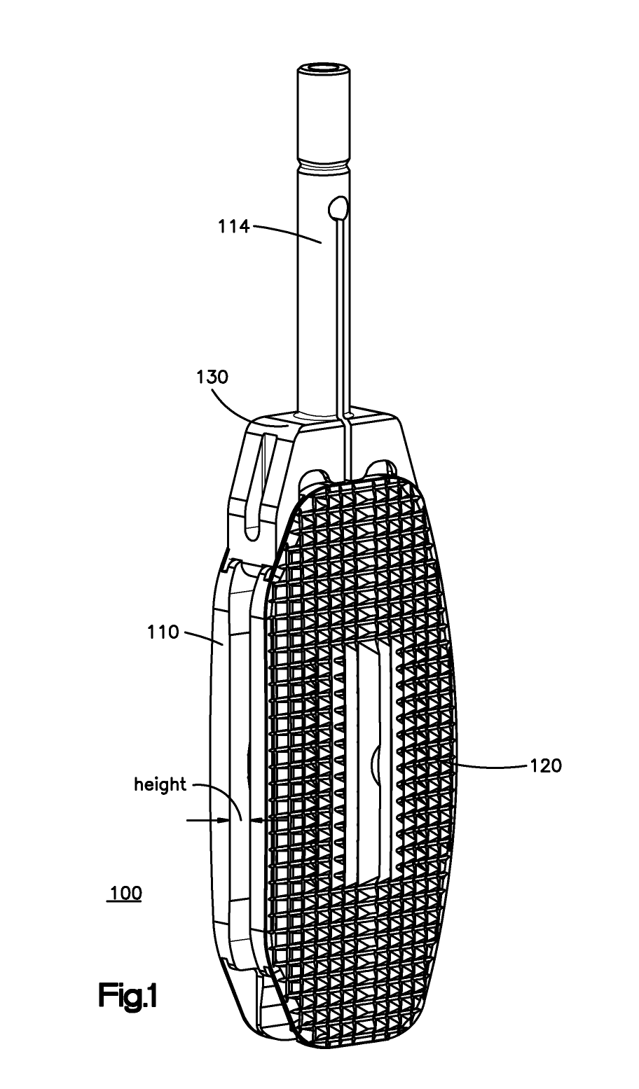

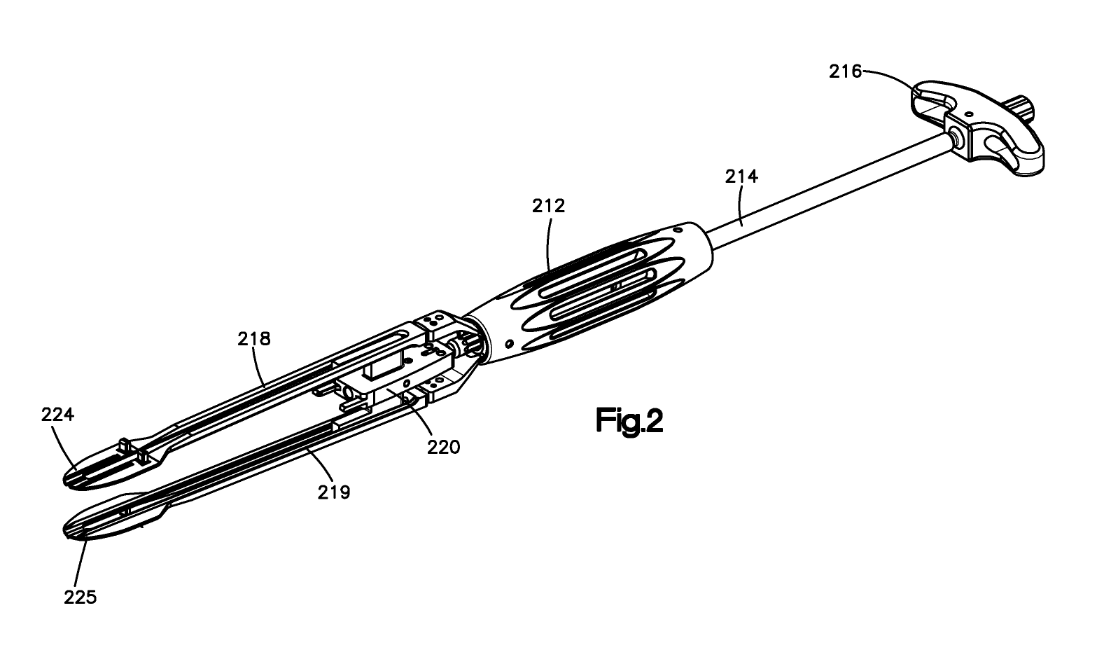

In an implementation, the loading station 300 comprises an adjustment mechanism (optional), such as a height dial 305, disposed on one of the holders (e.g., holder 301 as shown). The height dial 305 allows for controlled variation of the distance between the holders 301, 302. This distance corresponds to the different heights of the implant (e.g., the height between the endplates 110, 120 of the implant 100 shown in FIG. 1). As described further herein, the height dial may be turned or otherwise set, e.g. by a user, to the distance corresponding to the height of the implant that is being inserted into the loading station for mounting within the insertion device.

The loading station 300 comprises a distraction block 306. In an implementation, the distraction block 306 is disposed on or integrated within one of the holders (e.g., holder 301 as shown). The distraction block 306 is adapted to receive the distal ends 224, 225 of the blades 218, 219, respectively, of the insertion device 200, and maintain the insertion device 200 in a particular position (e.g., upright or vertical, etc.) depending on the implementation. Thus, the distraction block 306 is sized and configured to receive the distal ends 224, 225 of the blades 218, 219.

The distraction block 306 is configured to distract the blades 218, 219 from each other, by virtue of the shape and rigidity of the distraction block. For example, as the distraction block 306 receives the blades 218, 219, the blades 218, 219 are distracted or separated from each other so that the user may insert the implant 100 into the insertion device 200, as described further herein. For example, the user may remove the implant 100 from the loading station 300 and engage the implant 100 with the insertion device 200. For example, the user may remove the implant 100 from the loading station 300 and insert the implant 100 into the pusher block 220 of the insertion device 200. As described further herein, the insertion device 200 may be releasably connectable to the loading station 300 and may be disengaged or movable relative to the loading station 300.

Each holder 301, 302 of the loading station 300 comprises sides that act as a user interface such that a user can grasp or hold those sides while using the loading station 300 (e.g., while loading the implant 100 into the loading station 300, while loading the insertion device 200 into the loading station 300, while transporting the implant 100 from the holders 301, 302 to the insertion device 200, while loading the implant 100 into the insertion device 200, etc.). For example, as shown in FIG. 5, the holder 301 comprises sides 311, 321 that act as a user interface. Similarly, the holder 302 comprises sides 312, 322 that act as a user interface.

Additionally, each holder 301, 302 may comprise a side that acts as an implant interface, which corresponds to the locations of the loading station 300 for receiving the endplates 110, 120 of the implant 100. For example, as shown in FIG. 5, the holder 301 comprises a side 318 that acts as an implant interface. Similarly, the holder 302 comprises a side 319 that act as an implant interface. As shown in FIG. 5, the implant interface sides 318, 319 of the holders 301, 302 are parallel and face each other.

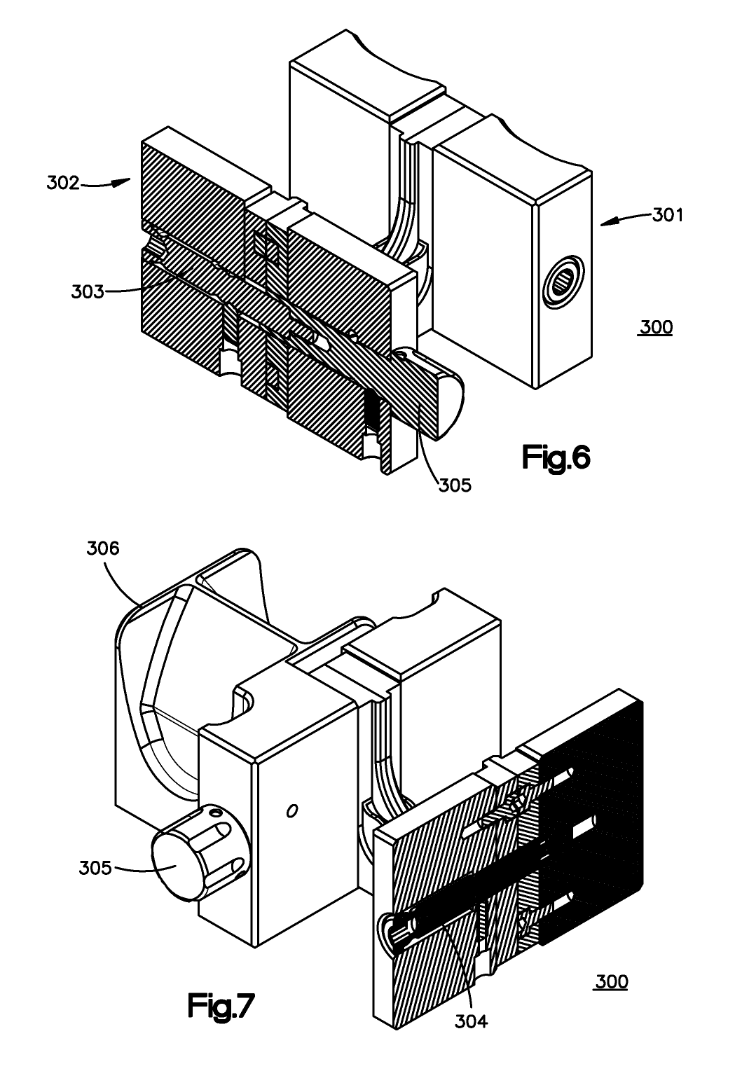

FIG. 6 is a cross-sectional perspective view of the loading station 300, and FIG. 7 is another cross-sectional perspective view of the loading station 300. More particularly, FIG. 6 shows the connection member 303 and the height dial 305 in cross-section, and FIG. 7 shows the connection member 304 in cross-section. Any means and/or techniques of connecting the holder 301 with the holder 302 may be used, such as any known rod and/or pin assembly, using one or more bores and/or passages, for example.

Alternatively, the holders 301, 302 may be comprised within a single solid device (i.e., a unitary structure, as opposed to an assembly of multiple structures), such that no connection members are used with respect to the holders 301 and 302 in the loading station 300. For example, the loading station 300 may be manufactured with both holders 301, 302 integrated into the loading station 300 without connection members therebetween. Moreover, any mechanism that may adjust the distance between the two holders may be used for the height dial 305. The height dial 305 or other height adjustment mechanism may be integrated with the connection member 303 and/or 304 or may be separate from the connection members 303, 304.

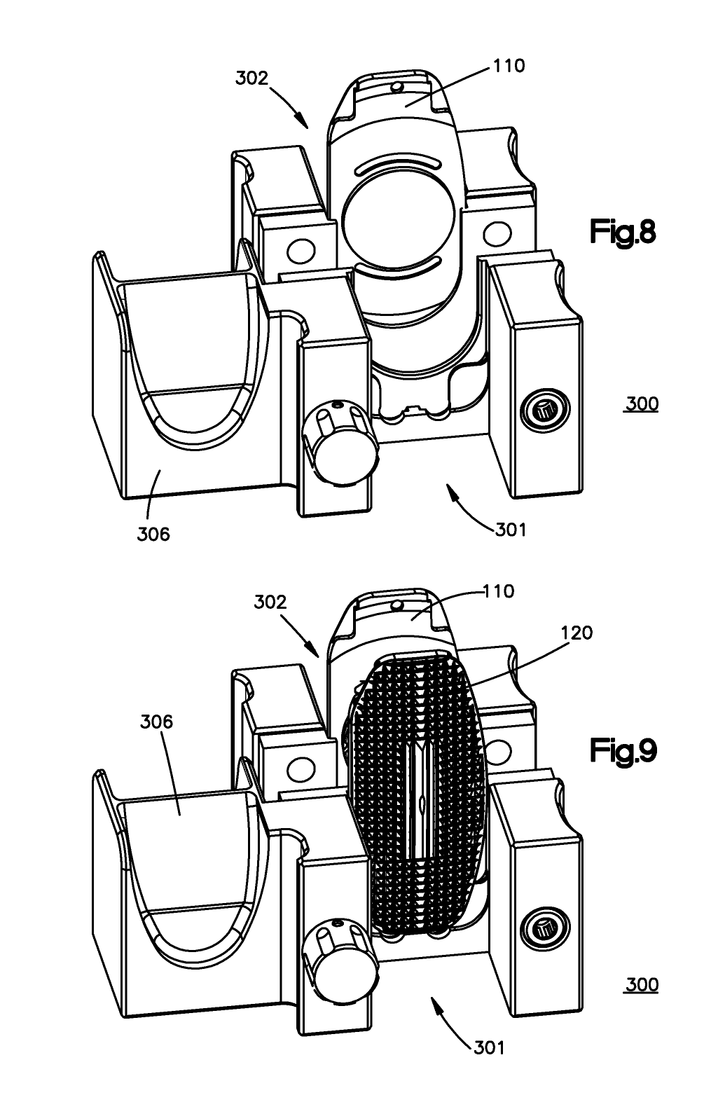

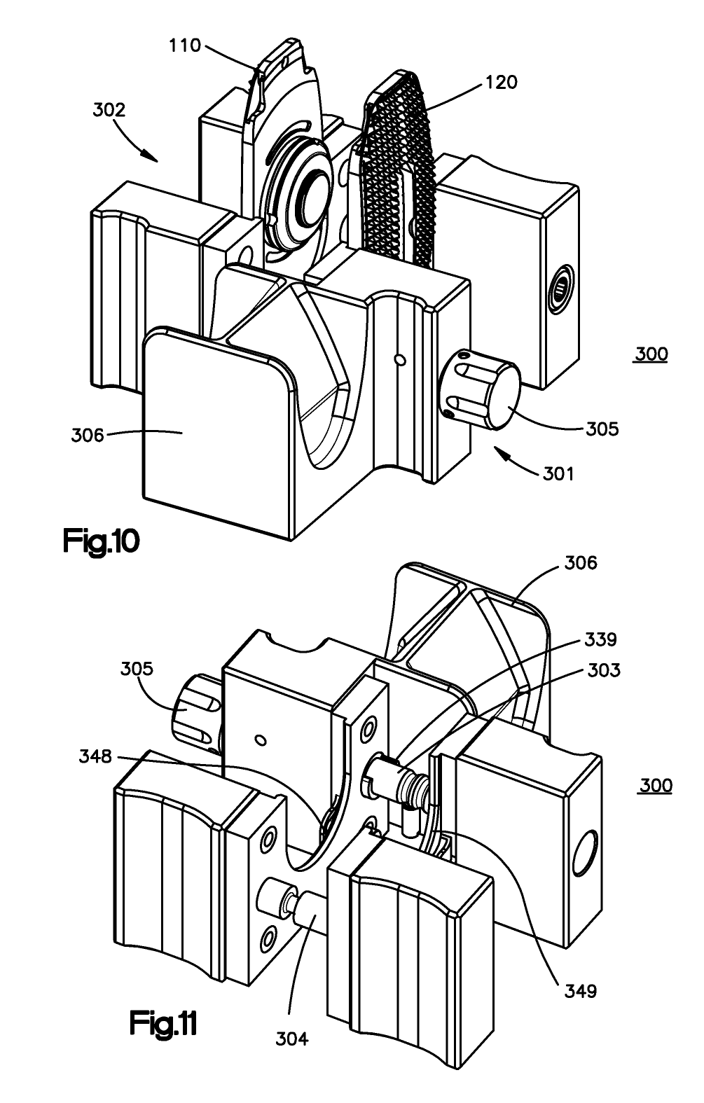

FIG. 8 is a perspective view of the loading station 300 receiving an implant, such as implant 100, and FIGS. 9 and 10 are additional perspective views of the loading station 300 receiving the implant 100. Regarding mounting an implant, a first part of an implant (e.g., endplate 110 of the implant 100) is received in (mounted onto) a slot at the implant interface of one of the holders and is maintained in a vertical position through this interface. Another implant part (e.g., endplate 120 of implant 100) is mounted onto a slot at the implant interface of the other holder and is maintained in a vertical position through this interface. Thus, as shown in FIG. 8, endplate 110 of the implant 100 is inserted (e.g., by a user manually or using an apparatus) into the slot 349 of the holder 302 where it is received and maintained in the vertical position. As shown in FIGS. 9 and 10, endplate 120 of the implant 100 is then inserted (e.g., by the user) into the slot 348 of the holder 301 where it is received and maintained in the vertical position. The endplates 110, 120 of the implant 100 may be inserted into the respective holders in any order or concurrently, depending on the implementation.

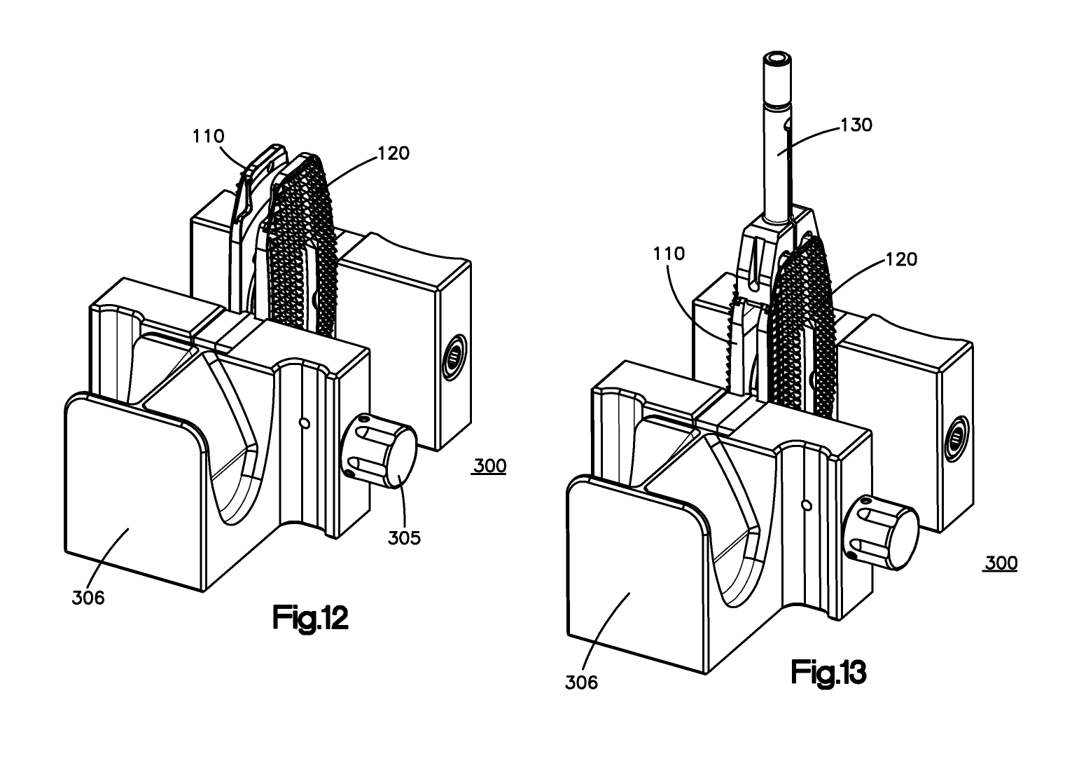

FIG. 11 is a perspective view of the loading station 300 with a height dial 305. FIG. 12 is a perspective view of two endplates of an implant mounted on the loading station 300, and FIG. 13 is a perspective view of two endplates of the implant coupled by a clamp and mounted on the loading station 300. Rotation on the height dial 305 defines the distance between the holders 301, 302 which corresponds to the height of the implant 100. Any number of different distances corresponding to any number of implant heights may be provided by the height dial 305 or other adjustment mechanism, depending on the implementation. In an implementation, a CAM system 339 may be used within the adjustment mechanism to allow for accurate separation of the holders 301, 302 corresponding to the implant height.

With both endplates 110, 120 of the implant 100 mounted onto the loading station 300 and the height dial 305 turned to the corresponding height, the loading station 300 is closed, as shown in FIG. 12. Depending on the implementation, the loading station 300 may be closed by the user (e.g., manually pushing the two holders 301, 302 towards each other). A clamp 130, as shown in FIG. 13, corresponding to the implant height may then be mounted onto both endplates 110, 120 of the implant 100 simultaneously using any known technique. The implant 100 is then ready to be introduced into the insertion device 200.

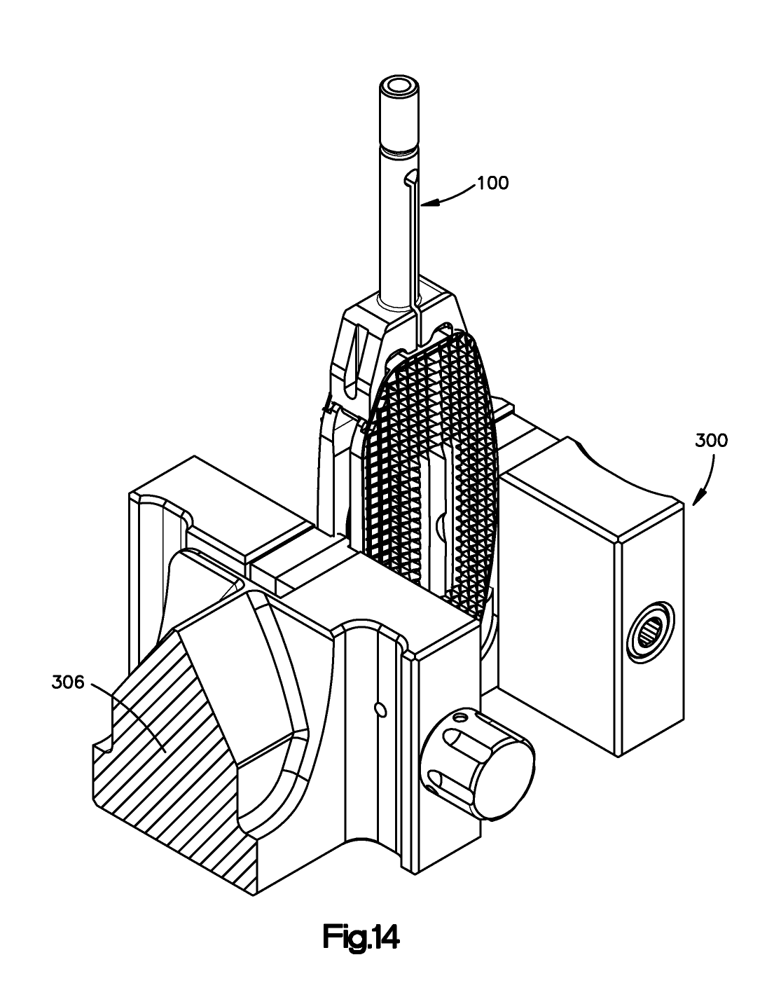

FIG. 14 is a perspective view of the loading station 300 with a distraction block 306 in cross-section. As shown in FIG. 14, attached to one of the holders is the distraction block 306 which can be used to receive and hold the insertion device 200 while spreading the insertion device blades 218, 219 apart from each other.

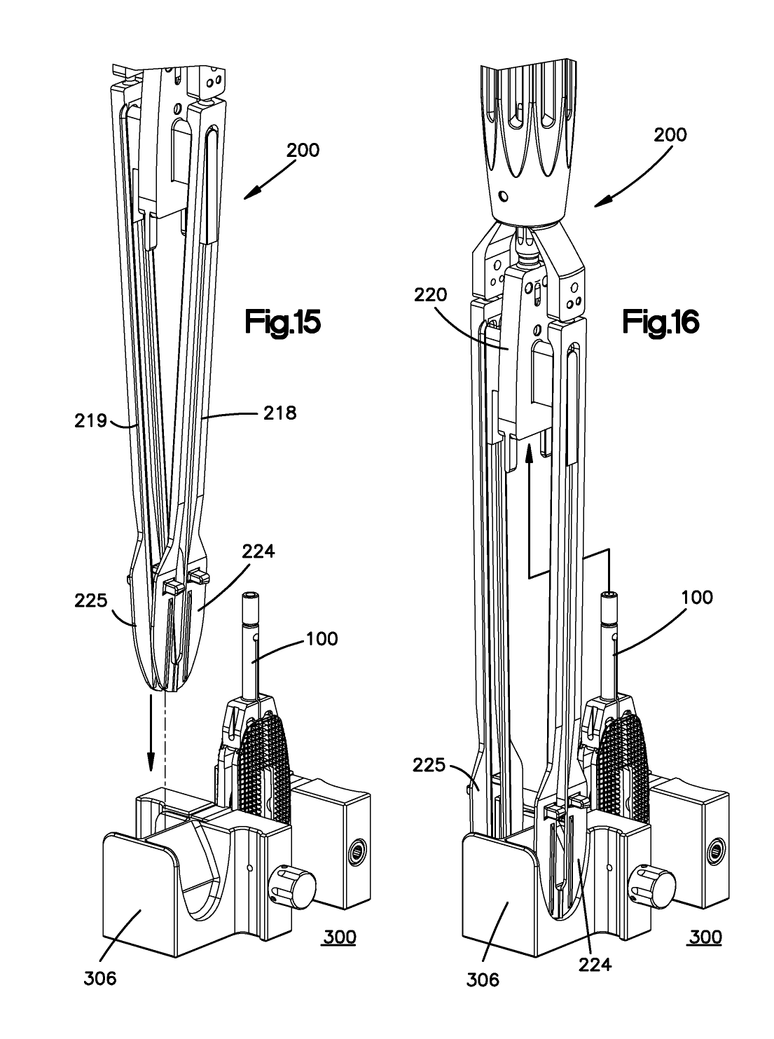

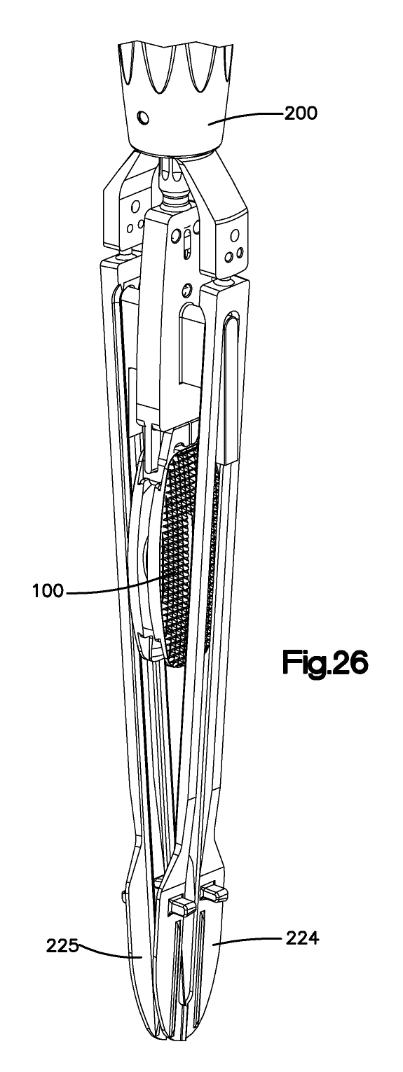

FIG. 15 is a perspective view of the loading station 300 with a mounted implant and receiving the insertion device 200 in the distraction block 306, and FIG. 16 is a perspective view of the loading station 300 with a mounted implant and the insertion device 200 mounted in the distraction block 306 to receive and engage the implant 100. As shown in FIG. 15, the insertion device 200 is lowered onto the distraction block 306 (e.g., by a user either manually or using an apparatus). As the distal ends 224, 225 of the blades 218, 219 contact the distraction block 306 and are pushed onto the distraction block 306, the blades 218, 219 separate from each other, as shown in FIG. 16. In this manner, in an implementation, the blades 218, 219 are separated from each other at their tips. The distraction block 306 then maintains the insertion device in a fixed position (e.g., vertical or upright). The user can then safely place the implant 100 (with clamp 130 attached) into the pusher block 220 of the insertion device 200. The insertion device 200 now has the implant 100 mounted thereon (as shown in FIG. 26 for example) and may be removed from the loading block 300 and subsequently used as desired. It is contemplated that the distraction block 306 may be any shape or construction that may receive, separate, and maintain the blades 218, 219 as described herein.

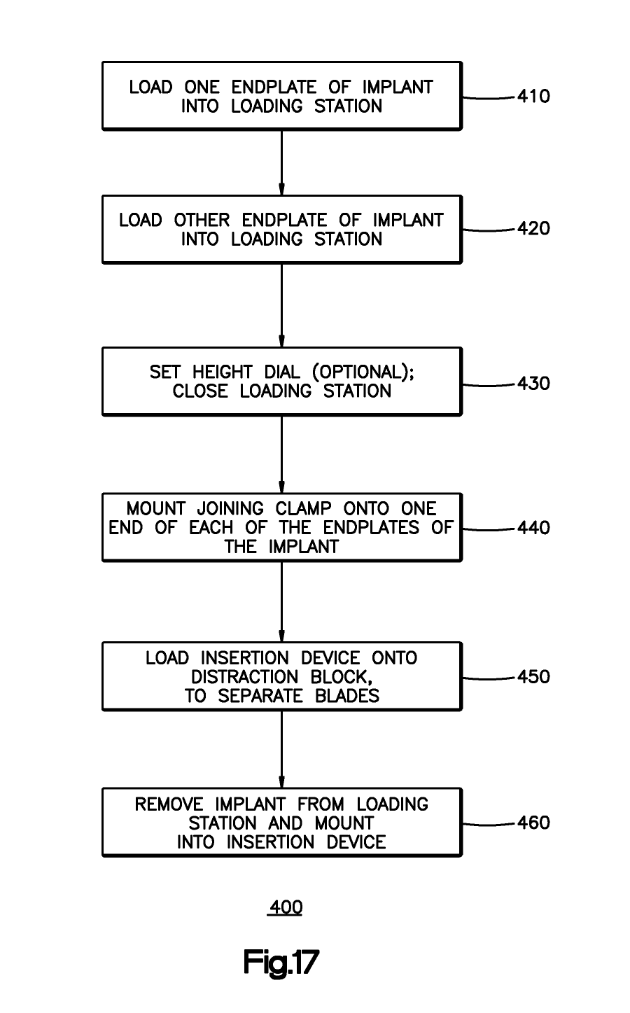

FIG. 17 is an operational flow diagram of exemplary processes 400 that may be performed as part of a procedure using an implementation of an example loading station, such as the loading station 300. At 410, one endplate of an implant, such as the endplate 110 of the implant 100, is loaded (e.g., mounted) into the loading station 300 (see e.g., FIG. 8). At 420, the other endplate of the implant, such as the endplate 120 of the implant 100, is loaded into the loading station 300 (see e.g., FIGS. 9, 10).

At 430, the height dial 305, if used as it is optional, may be set to the proper implant height, and the loading station 300 may be closed. At 440, a joining clamp, such as the clamp 130, may be mounted onto one end of each of the endplates 110, 120 of the implant 100 (e.g., the clamp is attached to the ends farthest from the ends that are mounted into the loading station, see e.g., FIG. 13).

At 450, the insertion device 200 may be loaded onto the distraction block 306 of the loading station, thereby separating the blades 218, 219 of the insertion device 200 (see e.g., FIGS. 15 and 16). At 460, the implant 100 may be removed from the loading station 300 (e.g., by the user) and mounted between the separated blades 218, 219 onto the pusher block 220 of the insertion device 200. The insertion device 200 with the mounted implant 100 may then be removed from the loading station 300.

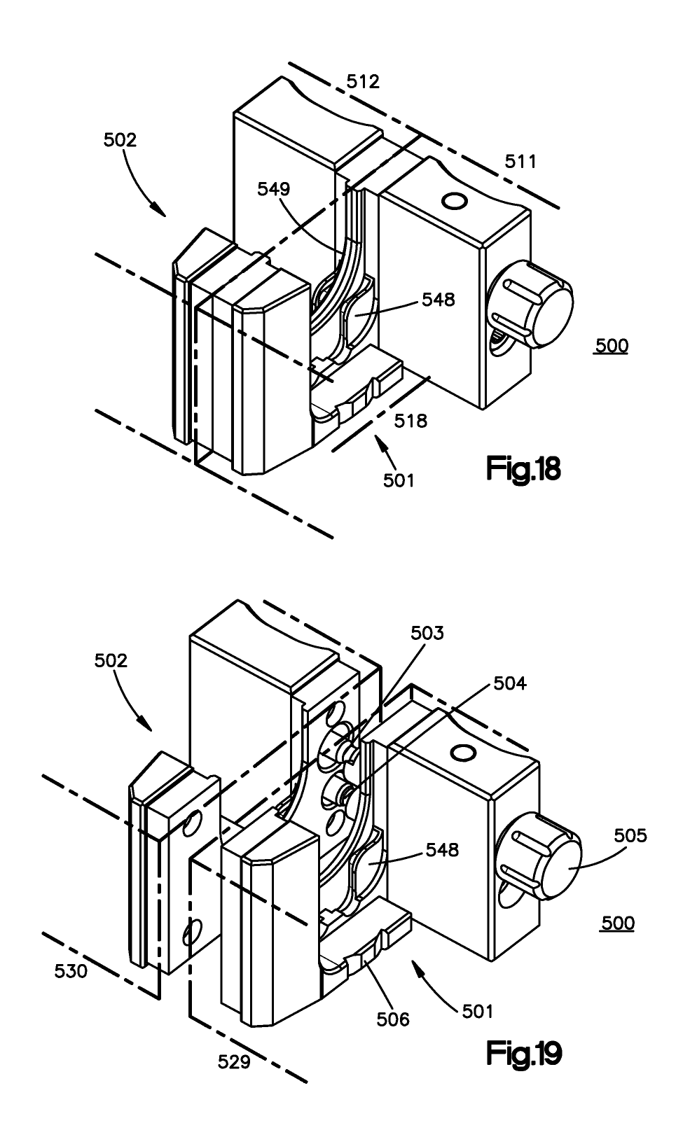

FIG. 18 is a perspective view of another implementation of an example loading station 500 that may be used to load the implant 100 into the insertion device 200, and FIG. 19 is an expanded perspective view of the loading station 500. As described further herein, unlike the loading station 300 which separates the blades 218, 219 of the insertion device 200 at their tips, the loading station 500 separates the blades 218, 219 on the side.

The loading station 500 comprises two holders 501, 502 that are coupled by two connection members 503, 504. Each holder is adapted to receive an endplate of the implant, e.g., in a slot of the holder. As noted above with respect to the loading station 300, each holder has a receiving portion, such as a slot or groove, which is sized and configured to receive a portion of the implant, such as an endplate of the implant. For example, the holder 501 is adapted to receive the endplate 120 of the implant 100 in a slot 548 or a groove, and the holder 502 is adapted to receive the endplate 110 in a slot 549 or a groove. Similar to the slots 348, 349 of the loading station 300, the slots 548, 549 may be any shape to receive and maintain the endplates 110, 120 in a particular position (e.g., upright or vertical, etc.) depending on the implementation.

The loading station 500 may comprise a height dial 505 (optional) or other adjustment mechanism disposed on one of the holders (e.g., holder 501 as shown). The height dial 505 allows for controlled variation of the distance between the holders 501, 502, corresponding to the different implant heights of the implant 100. The height dial may be turned or otherwise set, e.g. by a user, to the distance corresponding to the height of the implant that is being inserted into the loading station for mounting within the insertion device.

Each holder also comprises recess guides, shown as 506 for holder 501, and not shown for holder 502. The recess guides are disposed on the holders 501, 502 to receive the blades 218, 219 of the insertion device 200 and separate the blades from each other as the insertion device 200 is pushed towards (e.g., lowered onto) the loading station 500. More particularly, the recess guides are adapted to receive the distal ends 224, 225 of the blades 218, 219, respectively, of the insertion device 200, and maintain the insertion device 200 in a particular position (e.g., upright or vertical, etc.) depending on the implementation.

It is contemplated that the recess guides may be any shape or construction that may receive and guide the blades 218, 219 as described herein. In an implementation, the recess guides may comprise a plurality of indentations and/or grooves. The insertion device 200 may have at least one fastener or other component, such as ridges or teeth 242, 243 described further herein, for engaging the recess guides (e.g., indentations and/or grooves) such that the insertion device 200 is movable relative to the loading station 500 (e.g., the loading station 500 may move between the distal ends of the blades and the proximal ends of the blades). The insertion device 200 may be releasably connectable to the loading station 500 and may be disengaged or movable relative to the loading station 500.

As the insertion device 200 is pushed down through or along the recess guides, the blades 218, 219 are distracted or separated from each other so that the user may insert the implant 100 into the insertion device 200, as described further herein. For example, the user may remove the implant 100 from the loading station 500 and insert the implant 100 into the pusher block 220 of the insertion device 200.

Each holder 501, 502 of the loading station 500 comprises sides that act as a user interface such that a user can hold those sides while using the loading station 500. For example, as shown in FIG. 18, the holder 501 comprises side 511 that acts as a user interface, and the holder 502 comprises side 512 that acts as a user interface.

Additionally, each holder 501, 502 may comprise a side that acts as an implant interface, which corresponds to the locations of the loading station 500 for receiving the endplates 110, 120 of the implant 100 and corresponds to the side of each holder that has the recess guides. For example, as shown in FIG. 18, the holder 501 comprises a side 518 that acts as an implant interface, and the side of the holder 502 that acts as an implant interface is not shown, but is similar to the side 518. The implant interface sides of the holders 501, 502 are parallel and face each other.

Each holder also has a side for the insertion device interface. As shown in FIG. 19, the insertion device interface comprises side 529 of the holder 501 and side 530 of the holder 502. It is from this side (comprising sides 529, 530) that the insertion device 200 is introduced over the loading station 500 for mounting of the implant 100 from the loading station 500 onto the insertion device 200.

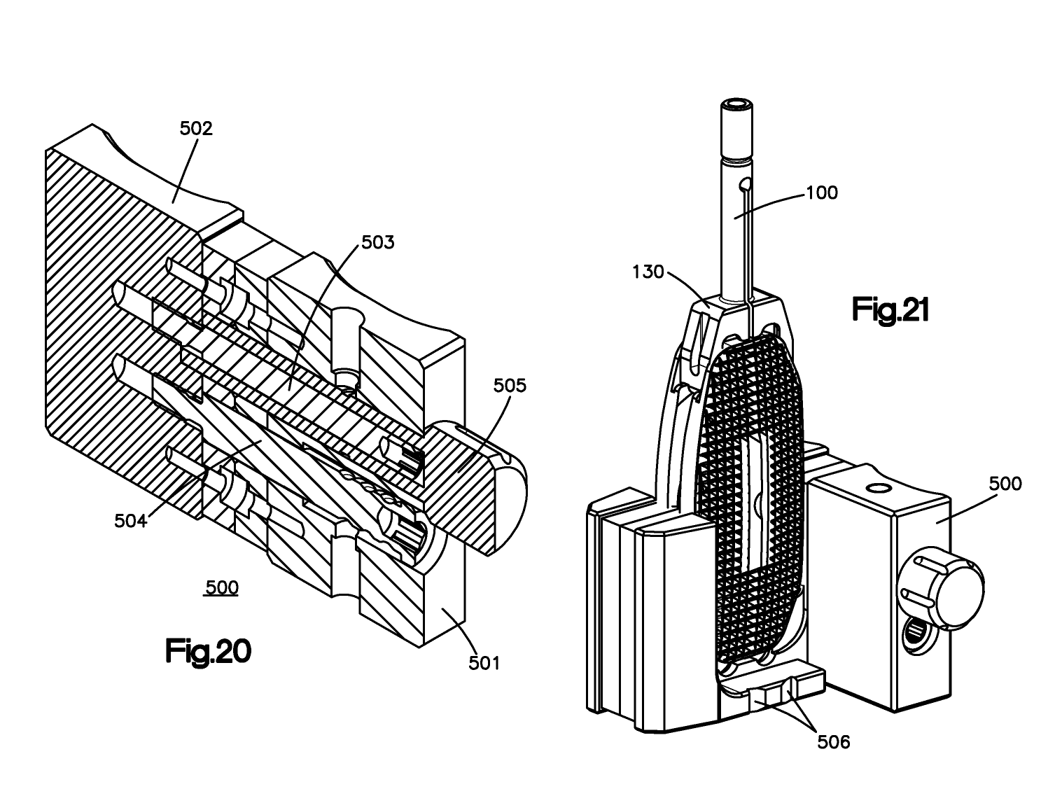

In an implementation, the holders 501, 502 are connected together via two connection members 503, 504 on the user interface side 511, 512 of the loading station 500. FIG. 20 is a cross-sectional perspective view of the loading station 500 and shows the connection members 503, 504 and the height dial 505. As with the loading station 300, any means and/or techniques of connecting the holder 501 with the holder 502 may be used, such as any known rod and/or pin assembly, using one or more bores and/or passages, for example. Alternatively, the holders 501, 502 may be comprised within a single solid device (i.e., a unitary structure), such that no connection members are used with respect to the holders 501 and 502. Moreover, any mechanism that may adjust the distance between the two holders may be used for the height dial 505. The height dial 505 or other height adjustment mechanism may be integrated with the connection rod 503 and/or 504 or may be separate from the connection members 503, 504.

The implant 100 loading procedure within the loading station 500 is similar to that of the loading station 300 procedure described above (e.g., with respect to FIGS. 8-13). FIG. 21 is a perspective view of two endplates 110, 120 of the implant 100 coupled by a clamp 130 and mounted on the loading station 500.

One endplate of the implant 100 (e.g., endplate 120 is received in (mounted onto) a slot 548, and a second endplate of the implant 100 (e.g., endplate 110) is mounted onto a slot 549 such that the two endplates 110, 120 are parallel to each other. As noted above, the endplates 110, 120 of the implant 100 may be inserted into the respective holders in any order or concurrently, depending on the implementation. The height dial 505 may be set (e.g., rotated, adjusted, etc.) to define the distance between the holders 501, 502 which corresponds to the height of the implant 100. Similar to the loading station 300, in an implementation, a cam system may be used within the adjustment mechanism to allow for accurate separation of the holders 501, 502 corresponding to the implant height.

With both endplates 110, 120 of the implant 100 mounted onto the loading station 500 and the height dial 505 set, the loading station 500 is closed and the clamp 130 is mounted onto both endplates 110, 120 of the implant 100 to join the two endplates of the implant 100, as shown in FIG. 21. At this point, the implant 100 is ready to be introduced into the insertion device 200.

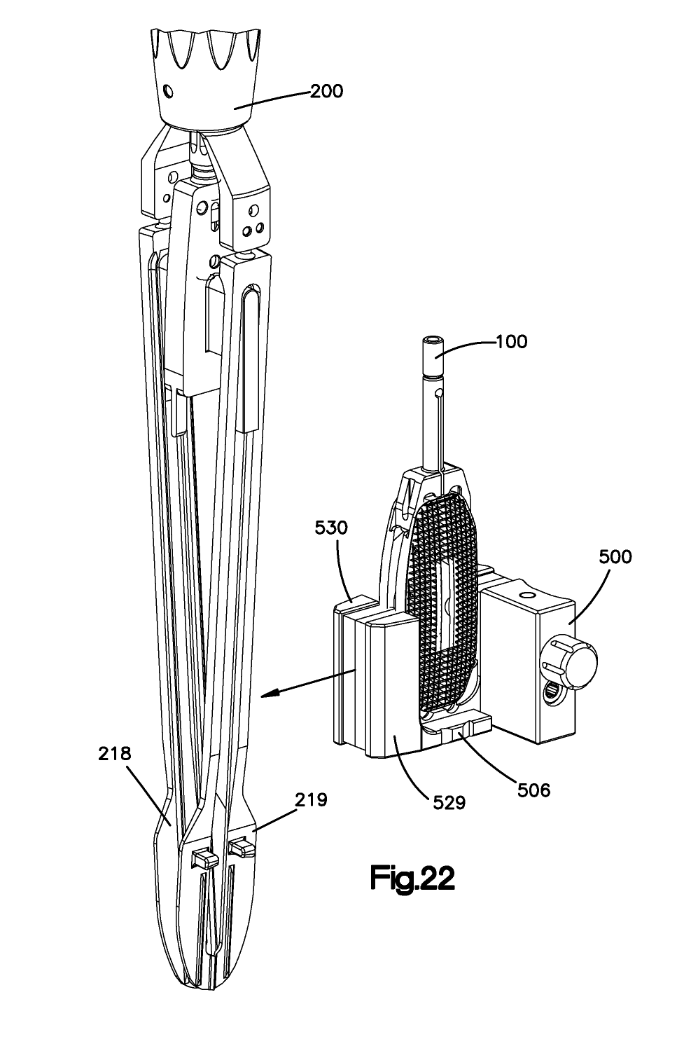

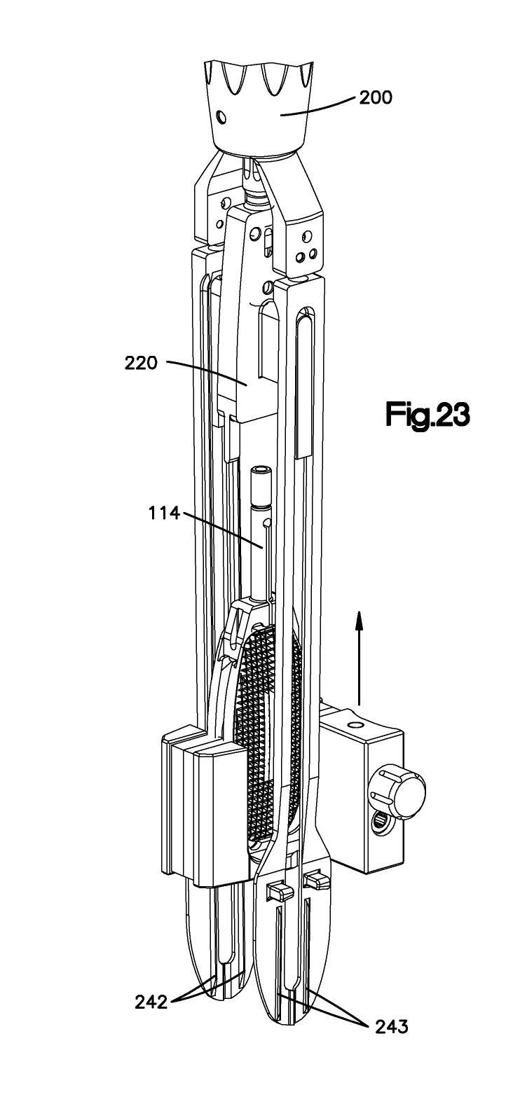

FIGS. 22-25 are perspective views of the loading station 500, the implant 100, and the insertion device 200 at various stages of mounting the implant 100 onto the insertion device 200 using the loading station 500. As shown in FIG. 22, the implant 100 is mounted in the loading station 500. The user, either manually or using an apparatus, may separate the blades 218, 219 of the insertion device 200 and guide the loading station 500 between the separated blades 218, 219. More particularly, the blades 218, 219 of the insertion device 200 are distracted from the lateral side against the lateral edges 529, 530 of the holders 501, 502 of the loading station 500. This is continued until the teeth 242, 243 on the inside of the blades 218, 219, respectively, of the insertion device 200 engage in the recess guides of the loading station 500, as shown in FIG. 23.

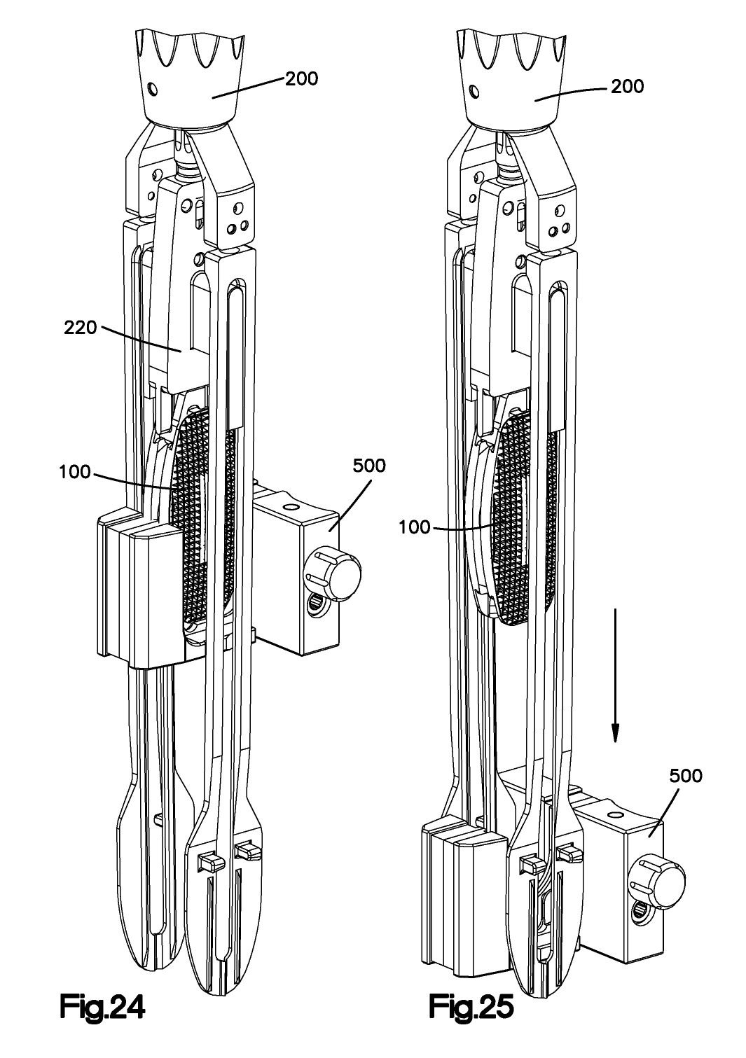

The loading station 500 is slid between the blades 218, 219 until the clamp shaft 114 mates with the pusher block 220 of the insertion device 200, as shown in FIG. 23. Once the implant assembly (comprising the loading station 500 and the implant 100) is locked inside the pusher block 220 as shown in FIG. 24, the loading station 500 can be removed as shown in FIG. 25. At this point, the blades 218, 219 retract automatically and the insertion device 200 is ready for implantation, as shown in FIG. 26.

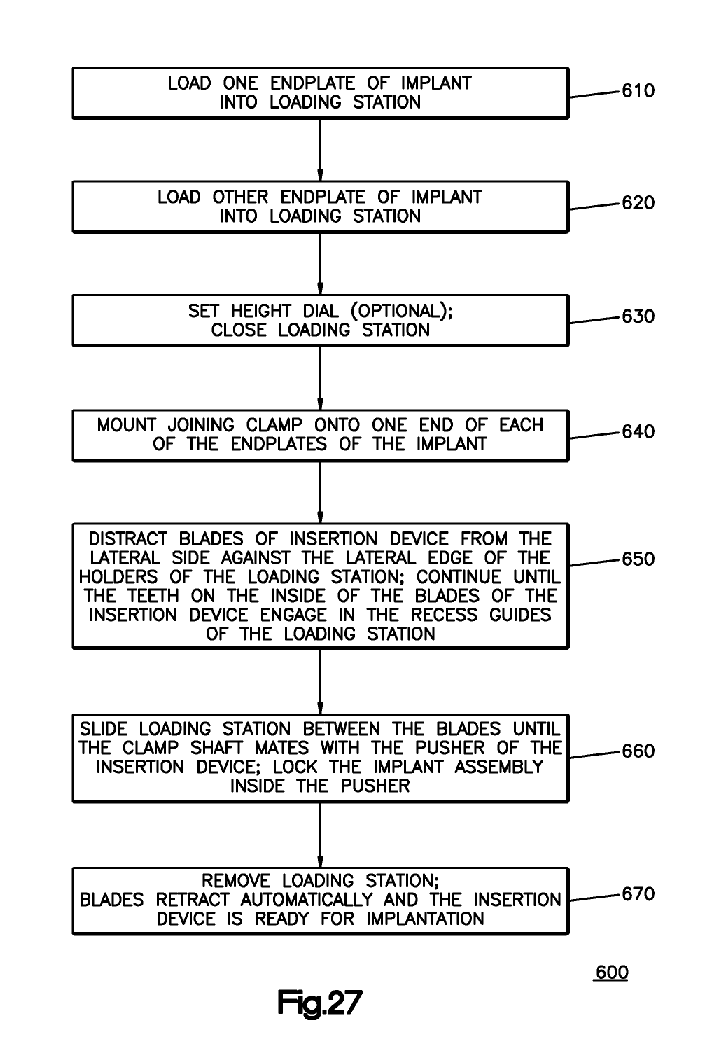

FIG. 27 is an operational flow diagram of exemplary processes 600 that may be performed as part of a procedure using an implementation of the loading station of an example loading station, such as the loading station 500. At 610, one endplate of an implant, such as the endplate 110 of the implant 100, is loaded (e.g., mounted) into the loading station 500. At 620, the other endplate of the implant, such as the endplate 120 of the implant 100, is loaded into the loading station 500. At 630, the height dial 505, if used as it is optional, may be set to the proper implant height, and the loading station 500 may be closed. At 640, a joining clamp, such as the clamp 130, may be mounted onto one end of each of the endplates 110, 120 of the implant 100, as shown in FIG. 21 for example.

At 650, the blades 218, 219 of the insertion device are separated or distracted (e.g., by the user) against the edges 529, 530 of the holders 501, 502 of the loading station 500 until the teeth 242, 243 on the inside of the blades 218, 219, respectively, of the insertion device 200 engage in the recess guides 506 of the loading station 500.

At 660, the user may slide the loading station 500 between the blades 218, 219 until the clamp shaft 114 mates with the pusher block 220 of the insertion device 200, thereby locking the implant 100 into the pusher block 220. Then, at 670, the user may remove the loading station 500, leaving the implant 100 mounted in the insertion device 200. The blades 218, 219 of the insertion device 200 retract automatically and the insertion device 200 is ready for subsequent use as desired.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims, and not limited to the foregoing description.

What is claimed is:

1. An apparatus for use in loading an implant into an insertion device, comprising:
a first holder configured to receive a first endplate of the implant;
a second holder connected to the first holder and configured to receive a second endplate of the implant;
a distraction block configured to receive the insertion device and distract a plurality of blades of the insertion device from each other during insertion of the implant into the insertion device.

2. The apparatus of claim 1, wherein the first holder comprises the distraction block.

3. The apparatus of claim 1, further comprising an adjustment mechanism disposed on the first holder or on the second holder and configured to allow for controlled variation of the distance between the first holder and the second holder, wherein the distance corresponds to a height of the implant.

4. The apparatus of claim 1, further comprising a plurality of connection members that couple the first holder with the second holder.

5. The apparatus of claim 1, wherein the distraction block is sized and configured to receive the distal ends of the blades of the insertion device.

6. The apparatus of claim 1, wherein each of the first holder and the second holder comprises a respective user interface side and a respective implant interface side.

7. The apparatus of claim 1, wherein the first holder and the second holder are comprised within a unitary structure.

8. The apparatus of claim 1, wherein the first holder and the second holder are configured to maintain the implant in a fixed position while the distraction block receives the insertion device.

9. A method for use in loading an implant into an insertion device, comprising:
loading the implant into a loading station;
loading the insertion device onto a distraction block of the loading station to separate a plurality of blades of the insertion device;
removing the implant from the loading station;
mounting the implant in the insertion device between the separated blades; and
removing the insertion device with the mounted implant from the loading station.

10. The method of claim 9, wherein loading the implant into the loading station comprises:
loading a first endplate of the implant into a first holder of the loading station;
loading a second endplate of the implant into a second holder of the loading station; and
mounting a joining clamp onto the first endplate and the second endplate to couple the first endplate with the second endplate.

11. The method of claim 10, further comprising setting the distance between the first holder and the second holder to a height corresponding to a height of the implant.

12. An apparatus for use in loading an implant into an insertion device, comprising:
a first holder configured to receive a first endplate of the implant and comprising a first plurality of recess guides configured to receive a first blade of the insertion device; and
a second holder connected to the first holder and configured to receive a second endplate of the implant and comprising a second plurality of recess guides configured to receive a second blade of the insertion device;
wherein the first plurality of recess guides and the second plurality of recess guides distract the first blade and the second blade of the insertion device from each other.

13. The apparatus of claim 12, wherein the first plurality of recess guides and the second plurality of recess guides distract the first blade and the second blade of the insertion device from each other during insertion of the implant into the insertion device

14. The apparatus of claim 12, wherein the first plurality of recess guides and the second plurality of recess guides are configured to engage a plurality of teeth on the distal ends of the first blade and the second blade.

15. The apparatus of claim 12, further comprising an adjustment mechanism disposed on the first holder or on the second holder and configured to allow for controlled variation of the distance between the first holder and the second holder, wherein the distance corresponds to a height of the implant.

16. The apparatus of claim 12, further comprising a plurality of connection members that couple the first holder with the second holder.

17. The apparatus of claim 12, wherein the first plurality of recess guides and the second plurality of recess guides are sized and configured to receive the distal ends of the first blade and the second blade respectively.

18. The apparatus of claim 12, wherein each of the first holder and the second holder comprises a respective user interface side and a respective implant interface side.

19. The apparatus of claim 12, wherein the first holder and the second holder are comprised within a unitary structure.

20. The apparatus of claim 12, wherein the first holder and the second holder are configured to maintain the implant in a fixed position while the first plurality of recess guides and the second plurality of recess guides receive the insertion device.

21. A method for use in loading an implant into an insertion device, comprising:
loading the implant into a loading station;
loading the insertion device through a plurality of recess guides of the loading station to separate a plurality of blades of the insertion device;
removing the implant from the loading station;
mounting the implant in the insertion device between the separated blades; and
removing the insertion device with the mounted implant from the loading station.

22. The method of claim 21, wherein loading the implant into the loading station comprises:
loading a first endplate of the implant into a first holder of the loading station;
loading a second endplate of the implant into a second holder of the loading station; and
mounting a joining clamp onto the first endplate and the second endplate to couple the first endplate with the second endplate.

23. The method of claim 22, further comprising setting the distance between the first holder and the second holder to a height corresponding to a height of the implant.
